(19) United States
(12) Patent Application Publication
(10) Pub. No.: US 2002/0099678 A1
(43) Pub. Date: Jul. 25, 2002

(54) Retail price and promotion modeling system and method

(76) Inventors: Brian Albright, Waconia, MN (US); Flora Delaney, Edina, MN (US)

Correspondence Address: Beck & Tysver, P.L.L.C., Suite 100, 2900 Thomas Avenue S., Minneapolis, MN, 55416, US

(21) Appl. No.: 10/043,543

(22) Filed: Jan. 9, 2002

Related U.S. Application Data
(60) Provisional application No. 60/260,562, filed on Jan. 9, 2001.

(51) Int. Cl. G06F 17/00

(52) U.S. Cl. 706/45; 705/1

(57) ABSTRACT

A management tool coordinates a modeling engine, databank, communication tool and supply chain functions to aid in the selection of an optimal promotion action, to monitor the results of that action, and to communicate those results to appropriate persons using browser-based, navigable web pages.

Applicants claim priority from provisional patent application U.S. Ser. No. 60/260,562 filed Jan. 9, 2001.

### FIELD OF THE INVENTION

The present invention relates generally to an artificial intelligence system and method for marketing-decision support, and more particularly to a system and method for predicting and analyzing the consequences of a pricing or promotional action in a retail setting. The invention further relates to a system and method for monitoring the actual result of marketing actions and communicating real-time or near-real-time information regarding the results.

### BACKGROUND OF THE INVENTION

All corporations have a need to measure their current or projected performance and compare those values to goals, budgets or forecasts. One of the challenges faced by a retail establishment is how to close the gap between current/projected performance and goals/budgets/forecasts. Typical goals include increasing market share for a particular product or product category, increasing gross margin, or increasing revenue. Strategies typically employed to achieve such goals include sales, i.e. discounting prices on selected items or categories of items, and promotions offering some incentive to purchase a particular product or item from a category of products. The effect of a given strategy is not necessarily transparent; that is, a retailer cannot easily predict the full effect of implementing one such strategy. For example, if the price for Product A is discounted, it is likely, and relatively predictable, that more units of Product A will be sold than would have been sold at full price. However, this greater number of sales may not generate significantly greater revenue in the end due to the discounted price. If the ultimate goal is to increase market share for Product A, however, this failure to dramatically increase revenue may not be a drawback to selecting the discounting strategy.

This is a fairly simple example illustrating the need to predict or model and analyze the consequences of a price/promotion strategy before it is implemented. In typical practice, the retailer has more sophisticated marketing strategies or tools that impact sales and profits in a significantly more complicated way. For example, offering one product at a discount might cannabalize sales from another product, and ultimately fail to yield greater revenue for the business of fail to meet another specified goal. Promotions often are selected which pair more than one product; for example, “buy a Brand A stapler and receive 10% off Brand B staples”. Such a promotion affects not only the sale of Brand A staplers and Brand B staples, but also the sale of other brands of staplers and staples, as well as the sale of paper clips. Predicting and assessing the consequences of such pricing and promotion possibilities in a reliable manner is beyond the capabilities of the unaided human mind. Thus, there is a need for computer-aided modeling system and method of pricing and promotion strategies to predict and analyze the consequences of such decisions, so that a retailer can select a strategy that is likely to meet specified goals. Further, there is a need for such a system to predict and analyze the consequences of such decisions across more than one retail establishment, and across different distribution channels.

### SUMMARY OF THE INVENTION

According to one aspect of the invention, a management tool links sales data and modeling algorithms to predict the results of pricing or promotion actions, thereby allowing a user to propose an action and view the predicted results. Graphical user interfaces allow a user to easily interact with the underlying modeling applications to set a specified goal, to query the consequences of proposed actions and to compare results from more than one potential action.

According to another aspect of the invention, the management tool monitors an implemented action and assesses the effect of the action on performance metrics. A graphical user interface displays performance metrics.

Another aspect of the invention provides networked access to the system and method, including a graphical user interface displaying in real time or near real time the results of a selected and implemented pricing or promotion action. Such information is provided in a secure manner to selected users. Preferably the results of the action are presented in terms of typical performance parameters, such as revenue generated, adjusted gross margin and “turn”, and a comparison of actual performance to budgeted or forecasted results or goals.

According to another aspect of the invention, users can select elements for a template for a web page displaying select company information, such as news, a scorecard showing pricing/promotion action results, the company's and/or its competitors' stock prices, current market capitalization and corporate PSP sales. Preferably such information is displayed in an easy-to-read condensed graphical manner, with links provided to more detailed information.

According to another aspect of the invention, the system and method provide convenient user-controlled access to historical performance metrics for pricing/promotion actions via networked connection to a server. The user can obtain performance metrics upon specifying one or more of the following parameters: product, vendor, channel or region.

According to another aspect of the invention, a web site is accessible to multiple, selected employees in a company, and such site provides links to: a web page allowing the user to define what-if scenarios showing the predicted results of a marketing action; a web page showing current performance metric results of an implemented marketing action and the likely outcome of such marketing action based on extrapolation of known results to date; and company specific information.

### BRIEF DESCRIPTION OF THE DRAWINGS

An exemplary version of a management tool in interaction with enterprise components is shown in the figures wherein like reference numerals refer to equivalent structure throughout, and wherein:

FIG. 1 is a schematic illustration of the relationships, according to the present invention, between a management tool and various enterprise components;

FIG. 2 is a screen shot depicting a user input screen that allows a user to define “what-if” scenarios generated by a modeling engine via the management tool and communicated via a communication tool, according to the present invention; FIG. 2 illustrates an example of a modeled scenario;

FIG. 3 is a screen shot depicting an example of an overview page generated by the management tool and communicated via a communication tool, according to the present invention;

FIG. 4 is a screen shot depicting an example of a promotion detail page generated by the management tool and communicated via a communication tool, according to the present invention;

FIG. 5 is a screen shot depicting an example of a ‘subscription’ selection menu of key metrics that a user has indicated an interest in. This item menu page or subscription selection menu allows a user to select information to appear on the overview page, with the menu page being generated by the management tool and communicated via a communication tool, according to the present invention; and

FIG. 6 is a screen shot depicting an example of a detailed scorecard page that displays performance metric data, with the scorecard page being generated by the management tool and communicated via a communication tool, according to the present invention, thus displaying the historical perspective of key performance indicators (KPI's).

### DETAILED DESCRIPTION OF PREFERRED EMBODIMENT(S)

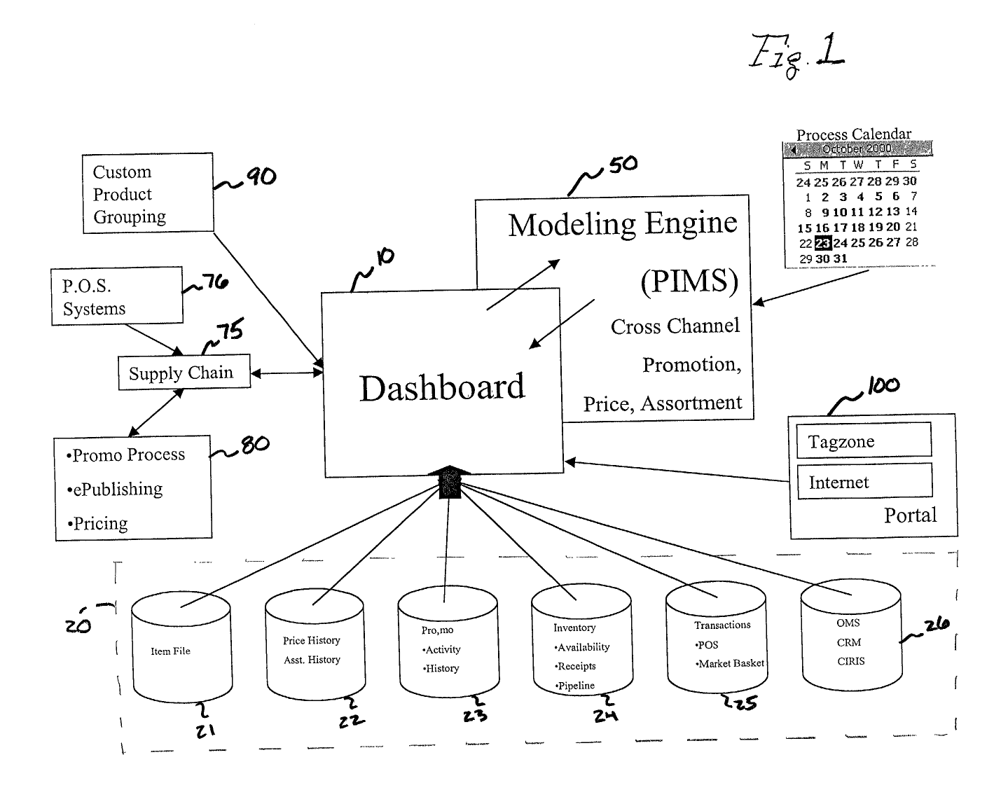

FIG. 1 illustrates schematically a preferred management tool 10 coupled with and linking various other components. The management tool 10 interacts with the various components to provide a convenient one-stop management support and information center, preferably accessible to selected users via a browser-based graphical interface.

One of the components coupled to the management tool 10 is a data bank 20 which includes one or more databases 21-26. Illustrated database 21 stores a list of items for sale. Database 22 stores data regarding the price history of items for sale and their “assortment history”. Database 23 stores information regarding promotions offered and the historical results of such promotions. Database 24 stores information regarding inventory availability, inventory receipts and data regarding quantities and delivery dates of inventory, pipeline data which illustrates where and when in the procurement process is the specific inventory. Database 25 stores information regarding transactions, such as point of sale and “market basket”. Market basket is an analysis that calculates what products are sold with other products when certain events transpire. For example, when a customer buys a radio, that customer will typically also buy batteries. Database 26 stores information regarding Order Management System, Customer Relationship Management, and CIRIS. In typical practice, these databases are relational and at least some are linked to others. Of course, the type of information stored by the databank 20 will depend on the particular application or environment in which the present invention is practiced, and the illustrated and above-described contents of databank 20 are examples of the type of data a retail sales operation might use.

Another component with which the management tool 10 interacts is a modeling engine 50. The modeling engine is software running on a relatively high capacity server. The modeling engine runs algorithms which predict the results of queried proposed actions. Some modeling engines are available off-the-shelf; others can be commissioned to be built custom or semi-custom for a particular business or application. These modeling engines use statistical, regression, predictive, and causal algorithms. Preferably, a modeling engine for optimal use in conjunction with the present invention, is relatively sophisticated and can model or predict: the effect of sales on one or more products as a result of a marketing strategy implemented for another or other products; the effect on sales of one or more products at one retail chain on sales of one or more products at another retail chain or at one retail location on another retail location; the effect on sales of one or more products in one distribution channel (e.g. brick-and-mortar store, internet, catalog) on the sales of one or more products in another distribution channel. “Effect on sales” has broad meaning, and includes, for example, one or more of the following: the effect on volume of products sold; the effect on revenue generated from sales; the effect on profit generated from sales; the effect on market share; the effect on gross margin. The results returned by the modeling engine are displayed via a graphical user interface 100 as described below. The display may include a comparison of different proposed actions.

Another component which interacts with the management tool 10 is the supply chain 75. The supply chain 75 involves all of the support processes for connecting price and promotion data to actual items on the shelves or those items yet to be manufactured. For example, when a discounted price is offered, the sale price must be incorporated into the point of sale system 76 in association with the product's unique identifier, such that at check-out the discounted price is accessed and used. Similarly, when a promotion involves more than one product, the terms of the promotion (e.g. buy one get one free; or buy Product A and get Product B for 20% off) must be incorporated into the point of sale system 76. Further, when a promotion is implemented, the promotion must be communicated to and coordinated with a number of functions in the company 80. This involves communication to and coordination with management and store personnel through notices and support materials, as well as to customers, such as through paper advertising, web site advertising, direct mail, direct email, point of sale displays and the like.

Another feature provided by the preferred management tool 10 is the ability to query the supply chain 75 to determine if quantity exists or could exist from suppliers and vendors to verify whether the forecast can be executed. For example, if the modeling engine predicts that sale pricing a product will yield sales of 20,000 units, but the stores only have 5,000 units in inventory and the distribution centers another 2,000 units, the management tool 10 must determine whether another 13,000 units can be obtained by a specific date. If either the delivery date cannot be met, or the vendor is not able to manufacture 13,000 units in the time frame, then the management tool 10, in association with the modeling engine 50, will determine that such a pricing action cannot be executed and will not suggest such a course of action.

The management tool 10 allows a user to initiate a promotion from the graphical user interface of the communication tool 100. For example, after seeing predicted results of a promotion, a user can submit a request to start a selected promotion, such as by clicking on a “Start this Promotion” button or the like on a graphical user interface provided via the communication tool 100. Upon submitting the request, the management tool 10 enters the promotion pricing info to the necessary databases and starts an order for sale price tags and other printed materials and advertising, as well as communicating to appropriate personnel.

Still another component with which the management tool 10 interacts is “Custom Product Grouping” 90. Custom Product Grouping 90 allows a user to select or identify multiple SKUs for analysis, even though the selected SKUs are not necessarily related according to the hierarchy (e.g. department, class, subclass) defined by the company's core merchandising system.

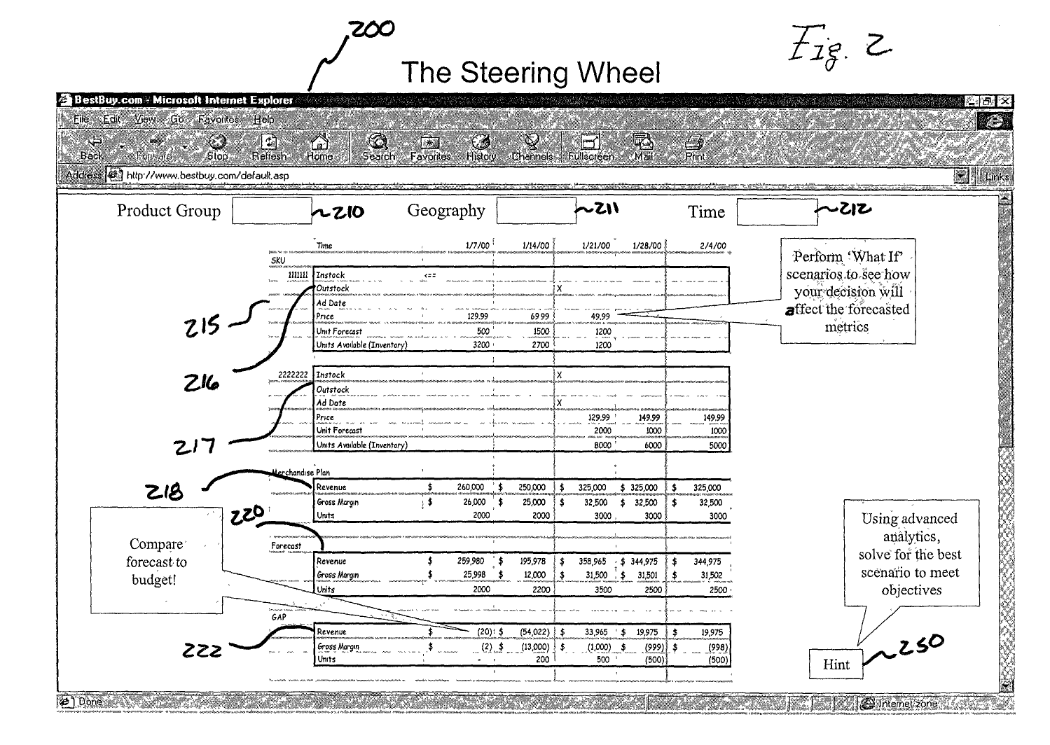

Another component with which the management tool 10 interacts is a communication tool 100. In a preferred embodiment, the communication tool 100 is a browser-based graphical user interface coupled to the management tool 10 to facilitate data communication between users and the management tool 10. Preferably the management tool 10 offers security features such that access to information is selectively controlled, allowing different levels of access. FIGS. 2-6 illustrate screens displayed selectively, upon user command, by the communication tool 10. The communication tool 100, via the management tool 10, provides convenient linked access to marketing decision support resources, such as the modeling engine 50 to predict results of proposed actions, and to information about promotion performance, as well as to company news. Navigation through the web pages or screens provided by the communication tool 100 is accomplished via typical hypertext links or the like

FIG. 2 illustrates a display screen 200 for collecting user input for what-if scenarios and for displaying the predicted results of proposed pricing or promotion actions. Screen 200 includes fill-in fields such as “Product Group” 210, “Geography” 211 and “Time” 212, by which the user can set selected parameters for the predictive analysis. The display 200 preferably includes a table 215 illustrating the predicted results of a course of action. The example table illustrated includes two SKU sections 216, 217 showing specified information about two SKUs arranged by date.

Preferably, the table includes a forecast section 220 showing relevant budgeted or forecasted goals. Further, the table 215 includes a gap section 222 illustrating the difference between the results of the planned action and the forecasted goals.

The table 215 includes columns 230 associated with specified dates to indicate time-dependant aspects of the promotion or pricing action. For example, as illustrated in sku section 216, SKU item 1111111 will be phased out, with its price being reduced weekly from $129.99 on January 7 to $49.99 on January 21. SKU111111 will not be offered for sale after January 28. Another product, SKU 2222222, in this example a replacement for SKU 1111111, begins selling on January 21 at a discounted introductory price. On January 28, its price will no longer be discounted. Both SKU sections 216, 217 show how many units are forecasted to be sold in each weekly time period, and how many units will exist in inventory in each weekly time period.

The merchandise plan section 218 displays revenue, gross margin and units goals of products to be sold in the product group, geography, and time group indicated above. The forecast section 220 shows the predicted SKU forecasts for revenue, gross margin and units sold for these two SKUs by weekly time period, and gap section 222 shows the difference between the predicted results of the plan (i.e. “merchandise plan”) and the forecasted goals for the two subject SKUs for each weekly time period. The illustrated example indicates that by the time the plan has been fully implemented, i.e. by February 4, the plan will have exceeded the forecasted goal for revenue by $19,975, but will be short of gross margin and unit sales goals by 998 and 500, respectively. If the overall objective of the plan was to increase market share, then the plan does not meet the goals, and another plan might do a better job of achieving the goal. However, if the overall objective was to increase revenue, then this plan meets that goal.

Preferably, the modeling engine 50 provides algorithms and processes to determine optimal solutions for specified goals. The “Hint” button 250 allows the user to ask the modeling engine 50 to determine a pricing or promotional plan (including price, promotion, assortment decision for each item for the time frame needed) that will optimally achieve the specified goals (such as revenue, gross margin or market share).

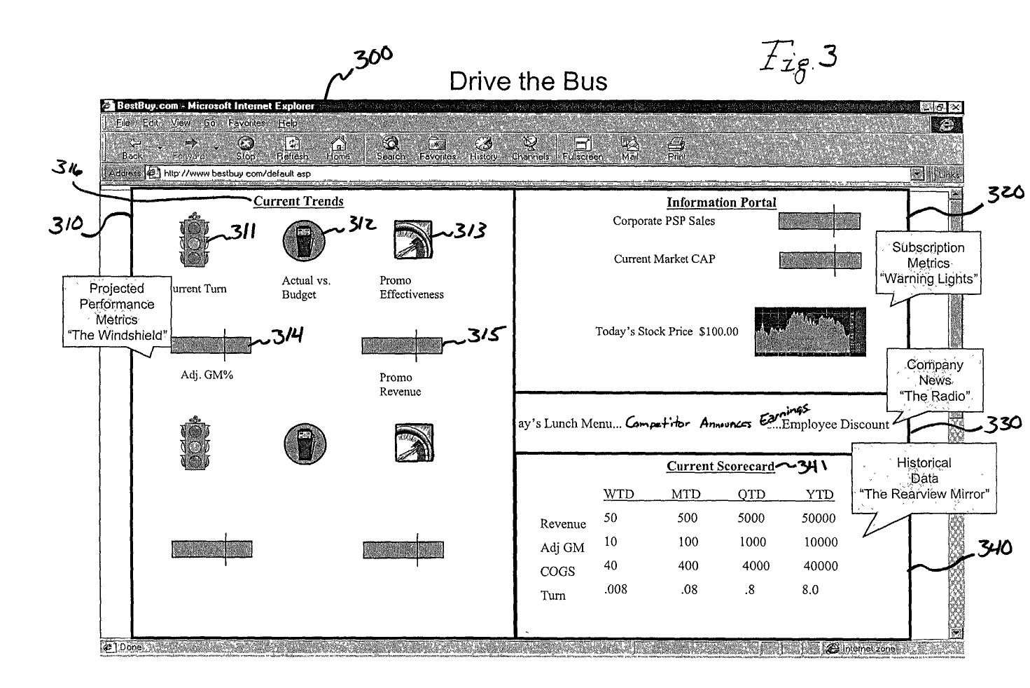

FIG. 3 illustrates another screen 300 provided to users by the communication tool 100. Screen 300 is an overview screen that provides some information at a glance, preferably in a graphical or table format, that describes a snapshot of recent performance. The overview screen 300 presents known information about what has already occurred. Screen 300 also provides links to screens providing more detailed information. Screen 300 is divided into several sections: a “current trends” section 310; an “information portal” 320; a news section 330 bearing selected real-time or near-real-time information relevant to the user; and a “current scorecard” section 340. The current trends section 310 displays projected performance metrics in a graphical manner. The following five items are presented in section 310 for each currently implemented promotion or pricing action: the “current turn” 311, an “actual versus budget” icon 312; a gauge indicated overall “promo effectiveness” 313; a bar graph showing adjusted gross margin percentage 314; and a bar graph illustrating revenue generated from the promotion 315. Preferably, the two bar graphs 314 and 315 include an indicator 316, 317 of projected performance; the bars are filled in to indicate the current measure of the adjusted gross margin percentage and the revenue generated from the promotion. Other performance metrics describing current trends may be displayed here as well or instead, depending on the context in which this system and method are employed.

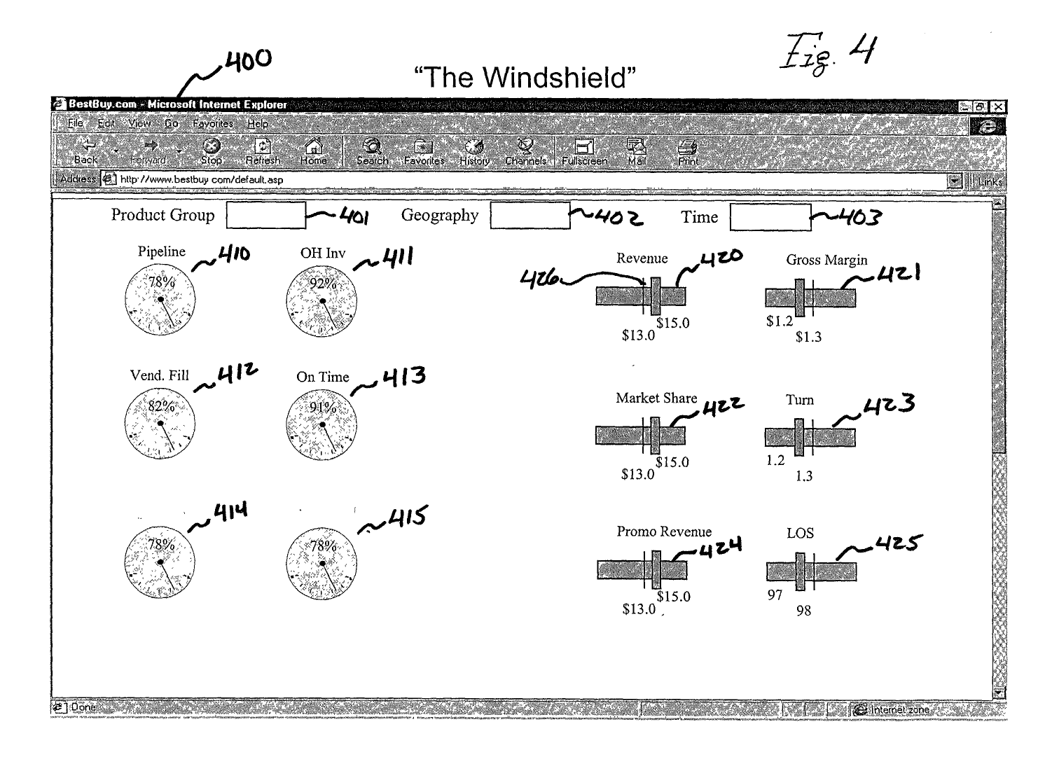

Section 310 includes a link 316 to a screen 400 that displays more detailed information about performance metrics, as illustrated in FIG. 4. Screen 400 provides fields for the user to specify one or more of the following: product group 401, geography 402 and a time period 403. Based on the input provided in these fields, the management tool 10 accesses the data bank 20 and sorts for the relevant data which is then displayed on screen 400, preferably in a graphical and easy-to-use manner. In the example illustrated in FIG. 4, the following supply-chain-related information is displayed via gauge-like indicators: “pipeline” 410, “OH Inv” (on hand inventory) 411, “Vendor Fill Rate” 412, “On Time Delivery” percentage 413, and other specified “arameters” 414 and 415.

Preferred screen 400 also includes several indicators of predicted performance metrics indicated by slide-bar graphs: revenue 420, gross margin 421, market share 422, turn 423, revenue generated by the promotion at issue 424 and “Level Of Service” (an instock measurement) 425. Preferably, each slide bar graph includes an indicator, e.g. indicator 426 on graph 420, of the goal for that metric so that the user can see at a glance what performance can be expected if current trends continue and how that predicted performance compares to forecasted or budgeted goals for that metric.

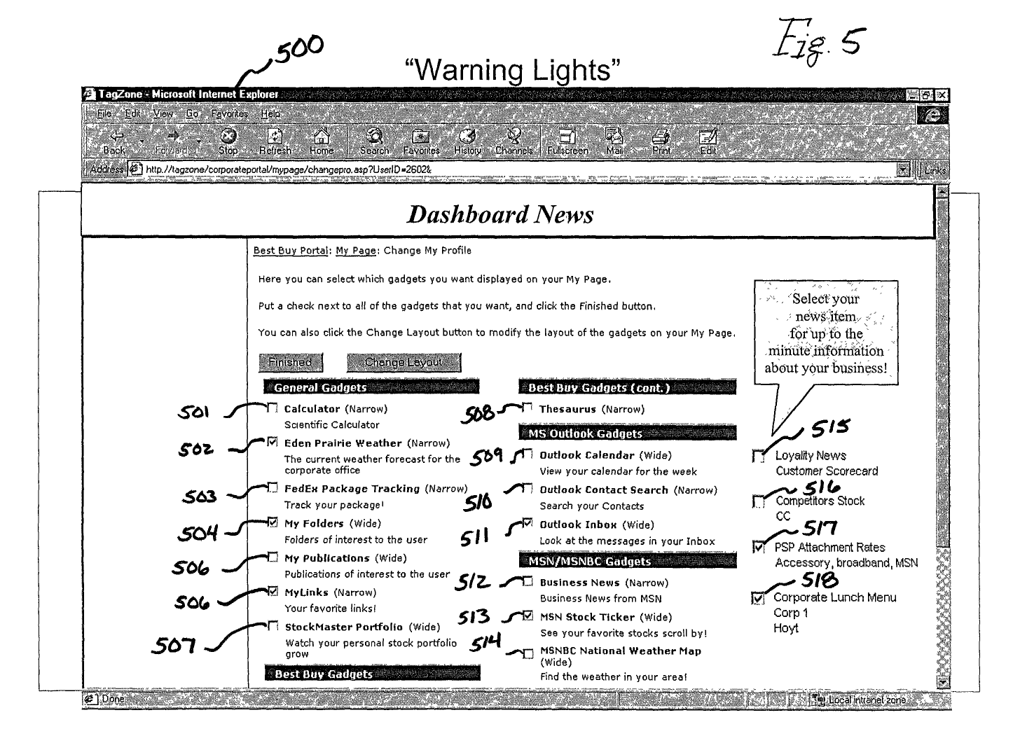

As noted above, the overview screen 300 includes an “information portal” section 320. Preferably, users are allowed to “subscribe” to, or select items to appear in this section that are of use to them. The items may be information generated by the management 10 in conjunction with the databank 20, or the items might be information accessed via the world wide web. In the illustrated example, the user has selected: “Corporate PSP Sales”, which would be generated via the databank 20; “current market CAP” which also would be generated via databank 20; and “Today's Stock Price” which might be available through the databank 20 or might be accessed via the world wide web. In addition, the user might select other items of interest. FIG. 5 illustrates an example menu screen 500 through which a user can select information to appear on the “Information Portal” 320 on overview screen 300. Selections listed in this example include a calculator 501, neighborhood weather 502, package tracking 503, personalized folders 504, links to personally-selected publications 505, other personally-selected web links 506, stock portfolio information for the user's personal portfolio 507, a thesaurus 508, links to the user's electronic organizer (calendar 509 and contacts 510), email inbox 511, business news 512, stock information for selected stocks 513, and national weather 514. This is just one example of a menu of selections; the menu can be tailored by a business to provide selections that would be of most use to its users. Menu screen 500 also includes selections that are specific to the company, its business or its competitors, such as: “Loyalty News, Customer Scorecard” 515; “Competitor's stock” 516 which will access and present news items regarding competitor's stock prices; “PSP Attachment Rates, Accessory, Broadband, MSN” 517 provides information relating to point-of-sale purchases, i.e. second and subsequent items sold in connection with a first item at the time of sale of the first item; and the Corporate Lunch Menu 518 for a specified lunch facility.

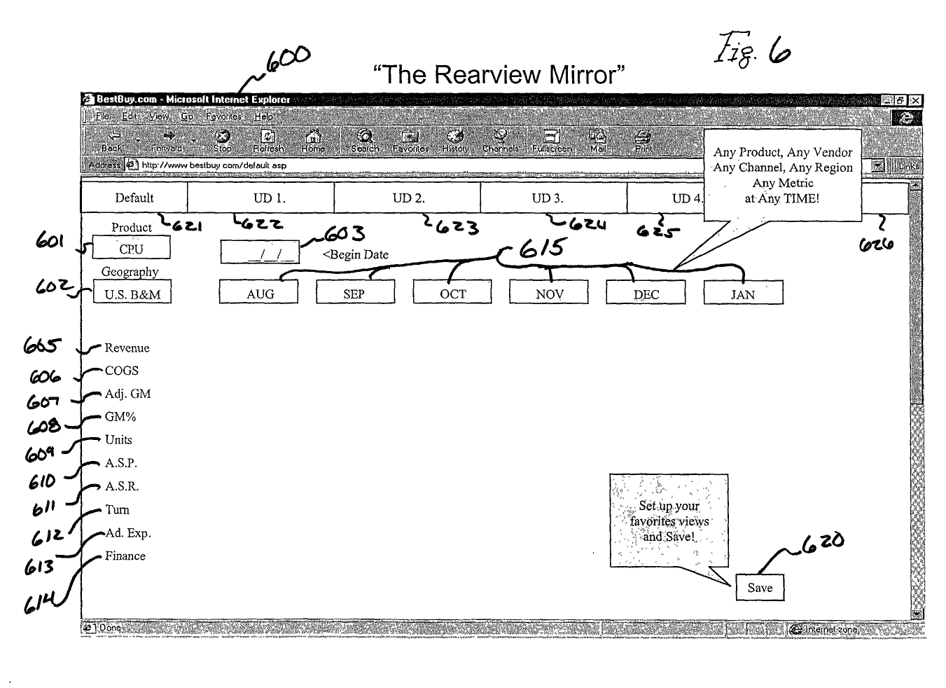

As noted above, the overview screen 300 includes a “current scorecard” section 340 which provides historical data regarding selected performance metrics for the company. The example illustrated in FIG. 3 includes revenue, adjusted gross margin, cost of goods sold (COGS) and turn over specified time periods including week-to-date, month-to-date, quarter-to-date, and year-to-date. Section 340 includes a link 341 to a detailed scorecard screen 600, illustrated in FIG. 6, containing more specific information and user-requested information. The detailed scorecard screen 600 provides fields for the user to enter a selected product 601, geography 602 and a beginning date 603. The management tool 10 then accesses performance metrics for the specified product. In the example illustrated in FIG. 6, the metrics that are displayed are: revenue 605, cost of goods sold 606, adjusted gross margin 607, gross margin percentage 608, units sold 609, A.S.P. 610, A.S.R. 611, turn 612, advertising expenses 613, and finance 614. These metrics are given in a columnar table, with columns 615 represented time periods. In the illustrated embodiments, the columns 615 represent months. Screen 600 provides a save button 620 that allows the user to save screens with particular selected product/geography/date parameters. These user-defined (“UD”) screens are assigned to navigational links 621-626 which appear across the top of the page in the example of FIG. 6 for convenient access by the user to the data of most concern to them. The company would typically assign default metrics to the “UD” buttons, but the user can then ‘create’ their own specific metric pages that are meaningful to them and assign a UD button to them for quick access to the specified page. For example, a manager can set up screens that measure their employees' specific areas independently of each other. Of course, the user may change these definitions as his/her needs change.

The following examples illustrate the preferred method of the modeling engine 50 and distinguish between the solutions and outcomes that would be achieved by common decision-making techniques, and those that result from the advanced analytics of the preferred modeling engine of the present invention in conjunction with the management tool 10 and other affiliated components.

### EXAMPLE 1

Category Revenue is down 10% from the budgeted.

Common Solution: One common solution is to advertise one or more items to drive additional traffic into your store. It is also common knowledge that advertising at a lower price will reduce margin rates for the item, but the sale is implemented anyway knowing this with the hope that there increase in volumes will outpace the reduction in margin rate per item. We may even have tools to tell us how much additional revenue may be generated by the item as well as the reduction in profit. Let's say we decide to advertise item “Alpha”.

Common Outcome: Although the advertised items perform as expected, the total revenue for the category did not meet its goal. This was due to the category cannibalization toward the advertised time at the expense of other, more profitable items in the assortment.

Solution via Management Tool 10 with Modeling engine 50: A user runs a simulation using modeling engine 50 via the management tool 10 which interacts with other affiliated components. Using advance analytics, the modeling engine recommends advertising item “Sierra”, an item that is not one of the better sellers.

Outcome via Management Tool 10 with modeling engine 50: The item Sierra performs as predicted, and total revenue is achieved as well as profit. The modeling engine 50, accessing data from the databank 20, ran algorithms that looked into the additional items that typically sold with Alpha and Sierra when they were advertised. This is known in the industry as “attachment”. Even though “Alpha” would have sold more units, Sierra had a 80% higher chance of selling item Bravo and Charlie items at full price. Because advertising Sierra caused a significant increase in Bravo and Charlie sales, the revenue goals were met with minimal profit degradation.

### EXAMPLE 2

The e-commerce channel of a retail corporation wants to increase category units by 10% to capture market share.

Common Solution: One common solution is to advertise the entire category to generate additional traffic into the web site. Typically, offering a category at a discounted sale price reduces profits for the category, but this sacrifice may commonly be accepted in the interests of achieving the specified ultimate goal of increasing market share.

Common Outcome: The e-commerce division gained market share and has decided to use this type of promotion again in the future when set to the task of increasing market share for a category. However, the brick and mortar (physical store) channel of the same corporation experienced a decline in revenue even though they had a positive trend for the period.

Solution via Management Tool 10 with Modeling engine 50: A user runs a simulation using modeling engine 50 via the management tool 10 which interacts with other affiliated components. Using advance analytics, the modeling engine recommends advertising a few hot selling items only. This was recommended because the engine 50 determined that 90% of the unit velocity was from select items only. Although market share will not be maximized for the e-commerce channel, it is maximized for the enterprise as a whole (i.e. both e-commerce and brick-and-mortar).

Outcome via Management Tool 10 with modeling engine 50: 90% of the market share objective was achieved for the e-commerce channel, and the revenue for brick-and-mortar channel was not affected. This recommendation optimized the entire enterprise, nor just one channel at the expense of the other. The modeling engine 50, in concert with the management tool 10 and the databank 20, determined not only how the e-commerce channel would perform but also the effect on the brick-and-mortar channel. The engine 50 found the optimal solution that would maximize the strategy with minimal effect to the other channel.

Although an illustrative version of the device is shown, it should be clear that many modifications to the device may be made without departing from the scope of the invention.

What is claimed is:

1. A marketing decision support system, comprising:
a) means for modeling results of a specified proposed promotion action;
b) means for storing historical sales data;
c) means for facilitating communication between a human user and said support system;
d) means, coupled to said modeling means, to said data storage means and to said communication means, for coordinating data communications amongst said data storage means, said modeling means and said communication means.

2. A marketing decision support system, comprising:
a) a modeling engine for predicting results of a proposed marketing strategy;
b) database linked to the modeling engine to supply the modeling engine with historical data to aid in predicting results of a marketing decision;
c) a communication tool having a graphical user interface allowing a user to define a what-if scenario for modeling by the modeling engine;
c) a management tool linking said communication tool to said modeling engine for data communication therebetween.

3. A marketing decision support system according to claim 2, wherein said communication tool is browser based.

4. A marketing decision support system according to claim 2, further comprising data storage for supply chain data and wherein said management tool draws data from said supply chain data storage and provides said supply chain data to the modeling engine to assist in its analysis of the results of a proposed marketing strategy.

5. A marketing decision support system according to claim 1, wherein said communication tool selectively displays: predicted results of a user-defined what-if scenario; performance metrics of an implemented marketing strategy; and predicted trend of an implemented marketing strategy.

6. A marketing decision support system according to claim 5, wherein said communication tool includes a menu of options for a user's selection to appear on a browser home page, said menu of options including company-specific items.

7. A marketing decision support system according to claim 2, wherein said modeling engine can model the effect on sales of a first product as a result of implementing a marketing strategy on a second product.

8. A marketing decision support system according to claim 2, wherein said modeling engine can model the effect of sales on a first product from one retail establishment as a result of implementing a marketing strategy on said first product from a second retail establishment.

9. A marketing decision support system according to claim 2, wherein said modeling engine can model the effect of sales on a first product sold through one sales channel as a result of implementing a marketing strategy on said first product sold through a second sales channel.
